(19) United States
(12) Patent Application Publication
(10) Pub. No.: US 2007/0006821 A1
(43) Pub. Date: Jan. 11, 2007

(54) Hand-held pet lead with adjustable handle

(76) Inventor: David K. Mitnick, New York, NY (US)

Correspondence Address: David K. Mitnick, 325 Riverside Drive, #52, New York, NY, 10025, US

(21) Appl. No.: 11/177,686

(22) Filed: Jul. 8, 2005

(51) Int. Cl. A01K 27/00

(52) U.S. Cl. 119/795

(57) ABSTRACT

The present invention is directed to a leash configured to open and fit around stationary objects in order to secure a dog or animal. More particularly, the present invention implements a securing system along select portions of the lead which can be used to adjust the size of the handle by unfastening the adjustable end of the handle, wrapping it around a stationary object and then securing the open adjustable end of the handle to a securing point on the lead.

### FIELD OF THE INVENTION

The present invention relates generally to an animal leash or lead, and more particularly, to a leash or lead with an adjustable handle for securing the animal to a stationary object.

### BACKGROUND OF THE INVENTION

Owners of dogs, cats, ferrets, and other domestic animals often use a hand-held lead with a pre-formed loop handle when they go for a walk with their pet. For people who live in an urban or city area, it is often convenient to walk their pet while also running an errand or going to a store for groceries. For the safety of the animal and convenience of the owner, and since many businesses prohibit pets from entering the premises, the animal must be temporarily tethered to a stationary or fixed object outside the establishment, such as parking meters, signposts, bicycle racks, security gates, and the like. To do so, the leash is typically fastened around the surface area of the stationary or fixed object by tying the hand-held lead into a knot or otherwise fastening the lead to the stationary or fixed object. While sometimes effective, this method can often be problematic. Knots are generally not secure, can be easily undone by the animal, can be cumbersome for the handler to secure (particularly if the fixed object is wide or has unusual dimensions), and can be difficult to tie in inclement weather such as snow or rain. Other means of fastening the lead to a fixed or stationary object—such as clips or hooks—require the handler to carry additional items, or disengage the lead from the animal while the handler is securing the lead.

Accordingly, there is a need for a leash that allows the handler of an animal to easily and securely attach the leash to any one of a variety of fixed or stationary objects without disengaging the lead from the animal while at the same time eliminating the need to carry extra items.

Prior attempts to address similar problems in U.S. Pat. Nos. 2,250,171; 4,165,713; and 4,998,507. However, none of these references disclose leashes where the size of the handle can be easily adjusted so that the lead can be readily secured to a stationary object in order to secure the pet. Although these conventional leashes have a preformed loop handle which fits a persons hand located at one end of the lead, the user cannot secure the lead to a stationary object without either tying the lead into a cumbersome and insecure knot or, if the stationary object is small enough, fitting the distal end of the lead through the loop handle and then extending it through the preformed loop handle. However, the pre-formed loop handle standard on most conventional leads does not fit around many stationary objects including those located on urban and suburban sidewalks, such as parking meters, sign posts, bicycle racks and the like. While the prior art is of interest, the known methods and apparatus of the prior art present several limitations which the present invention seeks to overcome.

### SUMMARY OF THE INVENTION

Accordingly it is an objective of the invention to provide an improved leash device which allows a person walking their dog or pet to adjust the size of the lead's handle to snuggly fit the users hand or to adjust the size of the handle.

It is another object of the present invention to allow the user to secure their pet to stationary objects of varying sizes by adjusting the size of the handle to fit securely around a stationary object to allow the user to temporarily leave their pet while they enter a residence, store or place of business.

A further objective of the present invention is to provide a leash handle which has a securing device attached to an adjustable, open end that can be secured to different latching points along the body of the lead.

It is another object of the present invention to solve the shortcomings of the prior art.

To accomplish the objectives of the present invention in accordance with a preferred embodiment thereof, there is provided, an adjustable leash for restraining an animal. The leash comprises a lead having a lead having a releasable clip suitable for securing the device to the animal, wherein the middle section of the leash is fitted with one or more securing receptors, and the first end has at least one securing device adapted to releasably engage one of the securing receptors so that the user can refasten and create an opening for holding the lead or securing the lead to a stationary object of varying sizes.

### BRIEF DESCRIPTION OF THE DRAWINGS

Other objectives, advantages and features of the present invention will become more readily appreciated and understood when taken together with the following detailed description of the preferred, albeit exemplary, embodiment in conjunction with the accompanying drawings, in which:

FIG. 1 is a side view of a preferred form of leash apparatus in an elongated position with the handle portion unfastened and elongated.

FIG. 2 is also a side view of a preferred form of leash apparatus with a dual fastening system.

### DESCRIPTION OF THE PREFERRED EMBODIMENTS

The present invention generally relates to a leash 10 leash having a handle 12 on one end, and a clip 14 located at the opposite end. The clip 14 operates to fasten the lead to a collar or harness worn around the neck, head or body of the pet. At least one male fastening device 16 is secured to the inner portion of the lead handle 12, and a female securing device 18 is attached to the main body portion of the leash 10. In a preferred embodiment of the present invention, a plurality of female securing devices 18 are provided along the length of the main body portion of the leash 10. The terms leash or lead may be used interchangeably herein. Preferably, the female securing devices 18 are spaced equidistant at regular intervals from the distal end of the leash to the first end of the leash. Of course the female securing devices 18 can be separated by other distances if desired. The leash 10 may be made of any fabric or material that is suitable for pet leashes, such as leather or nylon. In accordance with the present invention the handle 12 is fitted with a male fastening device 16 and a female securing device 18 are secured to each other in order to construct a loop which can comfortably fit the hand of the user while the user is walking their pet. The male and female fastening apparatus 18 can be constructed of any type of known or hereinafter developed, fastening device, including, but not limited to a hook and corresponding loop fastening system, velcro, button and snap, and/or a buckle. Since a plurality of female fastening devices 18 are provided in the preferred embodiment, the male fastening device can be fastened to any of these components to allow the handle and loop to be adjustable.

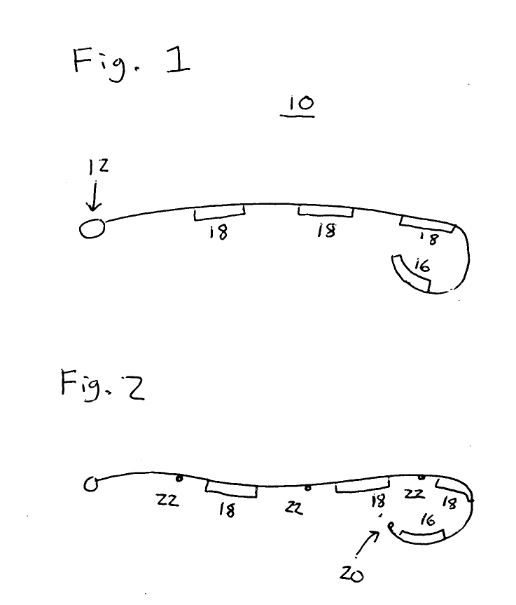

In the embodiment shown in FIG. 1, the leash utilizes a hook and loop fastening system, with the loop operating as female securing means 18 and the hook operating as the male fastening device 16. The hook and loop fastening system should be strong enough to withstand the force of a sudden pull or tug along the lead and remain fastened and easy enough to attach with minimal force by contacting the male and female securing devices. In these embodiments the female securing devices 18 are generally rectangular, having dimensions lengthwise 6 cm×6 cm along the full width of the leash 10. Of course, the fastening devices can be of other sizes and shapes without departing from the core concept of the present invention. The fastening system of FIG. 1 can also use other fasteners, such as velcro instead of the hook and loop fastening devices in the same manner as shown.

In a second embodiment of the present invention, the lead in FIG. 2 utilizes a velcro or hook and loop fastening system as shown in FIG. 1 as well as a button securing device which works to fasten the adjustable open end of the handle to the handle or the lead. The button securing device has one male component or stud 20 located on the first end of the adjustable handle which can be secured to the female components or sockets 22 located at four separate intervals along the lead. In this embodiment, the stud 20 is located approximately 2 centimeters from the male hook and loop or velcro fastening device located along the bottom facing portion of the adjustable handle 12. The sockets 22 are also located approximately two centimeters from the male hook and loop or velcro fastening device located at intervals along the body of the lead so that the stud 20 can be secured to the sockets when the hook and loop or velcro fastening system is secured.

While various embodiments of the present invention have been described above, it should be understood that they have been presented by way of example, and not limitation. It will be apparent to persons skilled in the relevant art that various changes in form and detail can be made therein without departing from the spirit and scope of the invention. Thus, the present invention should not be limited by any of the above-described exemplary embodiments, but should be, defined only in accordance with the following claims and their equivalents.

I claim:

1. An animal leash comprising: a first end, and a second end, wherein said first end comprises a connector for securing the leash to an animal; at least one female fastener located between said first and second ends of said leash; and at least one male fastener located between the female fastener and the second end of the said leash, wherein the male and female fasteners are configured to engage one another to form a loop to be secured to stationary objects of varying sizes.

2. The lead of claim 1, wherein the one or more of the securing devices located toward the first end of the lead is a male securing device and the at least two securing receptors located between the male securing device and the second end are female receptors.

3. The lead of claim 1, wherein one or more of the securing devices located toward the first end is a female securing receptor and the at least two securing devices located between the female securing device and the second end are male securing devices.

4. The lead of claim 2, wherein at least one of the securing receptors is located close enough to the first end to releasably engage a securing device to form a handle portion.

5. The lead of claim 2 wherein at least one of the female securing receptors is located close enough to the first end to releasably engage the male securing device to form a handle portion.

6. The lead of claim 3 wherein at least one of the male securing devices is located close enough to the first end to releasably engage the female securing receptor to form a handle portion.

7. The lead of claim 1 wherein one or more of the securing devices located toward the first end is a velcro-type securing device and the at least two securing receptors located along the middle section of the lead are velcro-type securing receptors.

8. The lead of claim 1, wherein one or more of the securing devices located toward the first end is a velcro securing device and the at least two securing receptors located along the length of the lead are velcro securing receptors that can releasably engage any of the one or more velcro securing devices in order to form a closed loop portion.

9. The lead of claim 1 wherein one or more of the securing devices located toward the first end is a velcro securing device and the at least two securing receptors located along the length of the lead are velcro securing receptors and where at least one of the velcro securing receptors is located close enough to the first end and can releasably engage a velcro securing device in order to form a handle portion that can be comfortably gripped by the hand of the user.

10. The lead of claim 1 wherein one or more of the securing devices located toward the first end is a velcro securing device with an adjacent buckle and the at least two securing receptors located along the length of the lead are velcro securing receptors with an adjacent socket so that when the velcro portions are releasably engaged together the respective buckle and socket can also be releasably engaged.

11. The lead of claim 1 wherein one or more of the securing devices located toward the first end is a velcro securing device with an adjacent socket and the at least two securing receptors located along the length of the lead are velcro securing receptors with an adjacent buckle that when the velcro portions are releasably engaged together the respective buckle and socket can also be releasably engaged.
